(19) United States
(12) Patent Application Publication
(10) Pub. No.: US 2010/0084470 A1
(43) Pub. Date: Apr. 8, 2010

(54) TWO-DIMENSIONAL BARCODE LOCALIZATION FOR CAMERA BASED DEVICES

(75) Inventors: Matthew R. Scott, Beijing (CN); Wei Jiang, Beijing (CN); Jonathan Tien, Beijing (CN)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/244,784

(22) Filed: Oct. 3, 2008

(51) Int. Cl. G06K 7/10

(52) U.S. Cl. 235/462.09

(57) ABSTRACT

Described is a technology in which a two-dimensional barcode symbol (e.g., a QR Code®) is located within an image by looking for angular signatures that indicate a high density of generally vertical and/or horizontal angles. An image is divided into blocks of pixels. Angles are associated with each pixel, forming an angular signature for the block based on how many pixels are associated with each angle. The angular signatures indicate which blocks have pixels associated with mostly generally vertical and/or horizontal angles. A region with the largest number of blocks having such angular signatures is determined, and a bounding box for the barcode symbol grown from that region block by evaluating nearby blocks to find the outermost blocks that contain the barcode symbol.

### BACKGROUND

A QR Code® (ISO/IEC 18004) is a two-dimensional barcode format that is becoming increasingly popular in facilitating various consumer-oriented scenarios. One of the ways to use a QR Code® is with a camera-equipped mobile phone.

However, current QR Code® decoding applications on mobile devices are limited in terms of localization, that is, the ability to automatically locate a QR Code® image within a larger container image. Localization is needed because it enables a QR Code® decoder to ignore background artifacts which could disrupt or slow down the performance of the decoding algorithm.

Current QR Code® decoding applications typically attempt to implement localization by scanning specifically for the QR Code® position detection patterns (three small black boxes) located at the three corners of the symbol to determine a bounding box. However, this is not particularly effective, as it is highly sensitive to environmental conditions (especially lighting, noise, and blur) as well as algorithmic performance.

The user can attempt to do the localization themselves by manually positioning the camera in such a way as to fill their preview screen entirely with the barcode image, typically within superimposed cross-hair graphics. This technique is error prone, and suffers from usability and/or accessibility issues. Moreover, manual localization is sometimes not possible, such as when the barcode is at a distance and the mobile phone lacks camera zoom functionality.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards a technology by which a barcode symbol (e.g., a QR Code®) is located within an image based on angular signatures corresponding to pixels that make up that QR code. In one aspect, an image is divided into blocks of pixels. Angles are associated with each pixel, and based on a count of the number of pixels in the block to which each angle corresponds, the block is given an angular signature. The angular signatures are then used to locate the barcode symbol.

In one aspect, the angular signatures indicate which blocks have pixels associated with mostly generally vertical and/or horizontal angles. Those blocks are chosen as candidate blocks. The region (within a set of regions of the image) with the largest number of candidate blocks is selected, and a bounding box grown from that region block by block, by including those blocks having mostly generally vertical and/or horizontal angles within the bounding box, and excluding others. When grown, the bounding box identifies the location of the barcode symbol.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 is a block diagram showing an example computing device/environment into which various aspects of barcode localization may be implemented.

FIG. 2 is a representation of determining an angle corresponding to a pixel for use in localization processing.

FIG. 3 is a representation of normalizing an angle for use in localization processing.

FIG. 4 is a representation of a histogram corresponding to an angular signature of a block showing pixel counts for each angle of a set of possible angles,

FIG. 5 is a flow diagram representing example steps for use in localization processing of an image.

FIG. 6 is a flow diagram representing example steps for determining candidate image blocks corresponding to possible barcode locations within sub-parts of the image.

### DETAILED DESCRIPTION

Various aspects of the technology described herein are generally directed towards locating a two-dimensional barcode symbol based on a signature gleaned from an angular distribution analysis of the distribution of the barcode symbol's pixels; the signature results from the block-like chunks that occur with high frequency within the symbol. While some of the examples described herein are directed towards a QR-code® barcode symbol, it is understood that these are only examples. For example, other symbols including other types of barcodes that have identifiable signatures may benefit from a similar location technique. As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used various ways that provide benefits and advantages in computing and image processing in general.

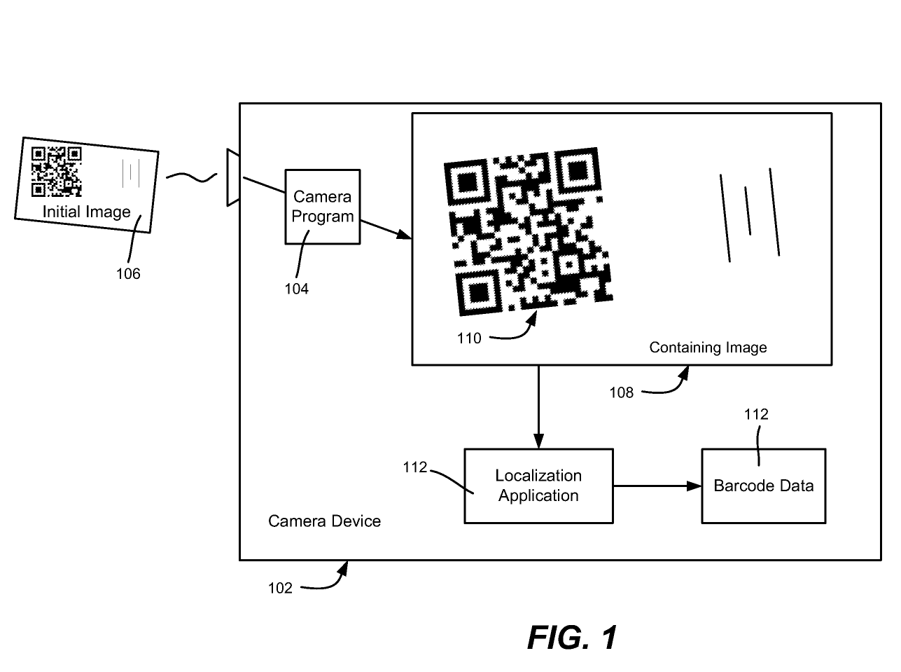

Turning to FIG. 1, there is shown a camera device 102 that via a camera program 104 captures an initial image 106 or the like to obtain a containing image 108 in device memory. The containing image includes a two-dimensional barcode 110, comprising a QR Code® in this example.

As described below, a localization application 112 (e.g., initiated by a device user) locates the two-dimensional barcode 110 within the containing image 108. The result is barcode data 112, e.g., in the form of a bounding box surrounding the barcode (which may be in the same memory location or copied to a different location) for use as needed by the user.

As will be understood, the localization application 112 requires limited manual labor, as the user need only point their device in the general direction of a QR Code® for the system to locate it. The localization application 112 is robust in that it can reliably locate a QR Code® bounding box within a containing image that suffers from low lighting, image noise/visual artifacts, a skewed capture angle and or focal distortion/blurriness. Additionally, the performance is fast enough on contemporary mobile devices to be considered real-time with respect to consumer use. Thus, the technology described herein is reliable even in poor environmental conditions, yet is sufficiently lightweight to maintain high computational performance even for devices with limited hardware capabilities.

In one implementation, various steps are performed, including angular distribution analysis. More particularly, instead of searching for the well-known position detection patterns, (the black blocks with surrounding squares located at the three corners of any QR Code® symbol), which is the basis of existing localization techniques, the localization application considers the entire QR Code® as a whole. That is, the application locates a QR Code® within a containing image by exploiting the fact that a QR Code®, in its entirety, has a somewhat unique signature when considering the angular distribution of its pixels; this is a result of the block-like chunks that occur with high frequency within the symbol.

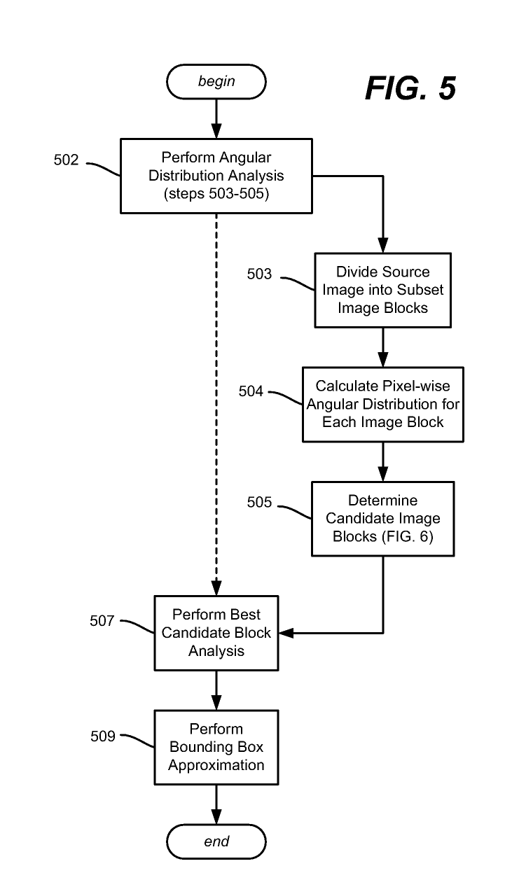

To perform the angular distribution analysis, as generally represented by step 502 (and sub-steps 503-505) of FIG. 5, the entire source image is divided into subset image blocks (step 503). In general, this reduces the locating problem into smaller problems that make the system more resilient to interference caused by visual artifacts and other environmental conditions. This works because when the smaller problems are solved, neighboring blocks that are determined to be likely parts of the QR Code® help to indicate the most likely position of the QR Code®. Note that the actual pixel size of the blocks is application-specific.

For each image block, a pixel wise angular distribution is calculated (step 504). Note that the image is initially processed to detect edges. A suitable algorithm for this task is a convolution mask (such as Sobel) to evaluate the gradient of the axis X the axis Y of an image A, denoted as Gx and Gy, as shown in the Sobel Convolution Matrices below:

$${G}_{x} = [ \begin{matrix}+ 1 & 0 & - 1 \\ + 2 & 0 & - 2 \\ + 1 & 0 & - 1\end{matrix} ] * A and {G}_{y} = [ \begin{matrix}+ 1 & + 2 & + 1 \\ 0 & 0 & 0 \\ - 1 & - 2 & - 1\end{matrix} ] * A$$

The angle value of each pixel is derived using the following equation:

Angle(x,y)=tan⁻¹GY/Gx

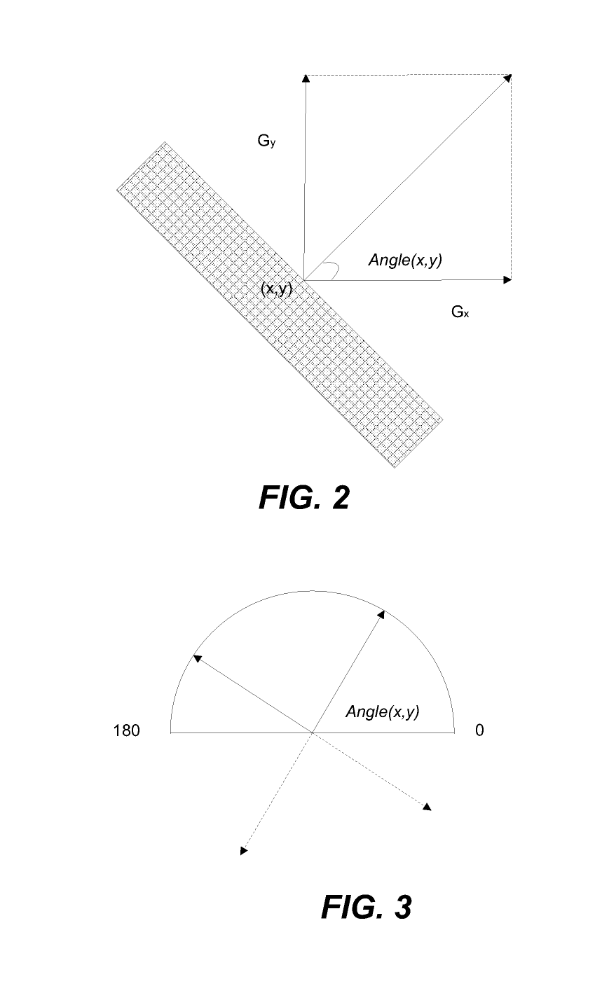

FIG. 2 represents the angle computation, in which for each pixel at coordinate(x,y), Gx and Gy is evaluated first using the Sobel mask; from there, the angle of the pixel at that point is derived. After calculation, each angle is normalized over the range 0° to 180°. This is accomplished by treating the angle Z and Z+180° as the same value. The angle normalization result is represented in FIG. 3.

In one implementation, an optimization is performed. More particularly, a fast method of storage and lookup of angular computation data is accomplished by reusing a temporary 8-bit image of the same dimensions as the source block, where each pixel is a byte that now holds a value corresponding to its derived angle (0° to 180°).

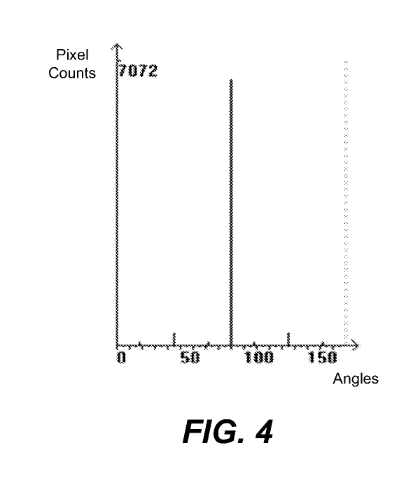

An angular distribution representing a measuring block is generated by measuring (e.g., counting) the angle values that show up most often; this corresponds to the block's angular signature. In FIG. 4, such an example distribution is shown, generally in histogram form, with the x-axis representing the angles in degrees, and the y-axis representing the pixel count in an example image block. As the distribution indicates for this block, the two most common angles are 0° and 90°—this represents vertical and horizontal lines respectively, which are the most common features of a QR Code® symbol. The lesser common, but still prevalent, angles are 45° and 135°—these represents the corners that intersect the vertical and horizontal lines, thus completing the box-like graphics that constitute a QR Code® symbol. Note that FIG. 4 is an ideal (or almost ideal) example for purposes of explanation; in actual images, where a barcode symbols if found, there are more counts than for just these four angles.

With respect to angled images, various mechanisms may be used to account for users not holding the camera perfectly straight with respect to capturing the image. One mechanism is based on pre-processing the image using known techniques to straighten the image before attempting to locate the barcode symbol as described herein. Another mechanism, described herein, anticipates the possibility by evaluating counts at a range of angles near ninety degrees, e.g., whether the counts are high at an angle of ninety degrees plus or minus some adjustment number of degrees. As used herein, “generally” vertical and/or horizontal refers to any angles within such a range, including exactly vertical and exactly horizontal. Generally horizontal angles also may be considered, instead of or in addition to generally vertical angles. Another mechanism that may be used in addition to or instead of the above mechanisms is to look for peaks in angle counts that are separated by around 90° relative to one another rather than relative to a straight image; for example, if a user holds a camera at 15° degrees relative to a straight image, barcode symbols will have peaks around 15° degrees and 105° degrees.

Many blocks may fit within the allowed distribution thresholds. The application thus determines candidate image blocks by comprising blocks that are likely part of a QR Code®. Note that this requires some further analysis because in real world images the angular distribution for a block will not be as cleanly-defined as represented in FIG. 4.

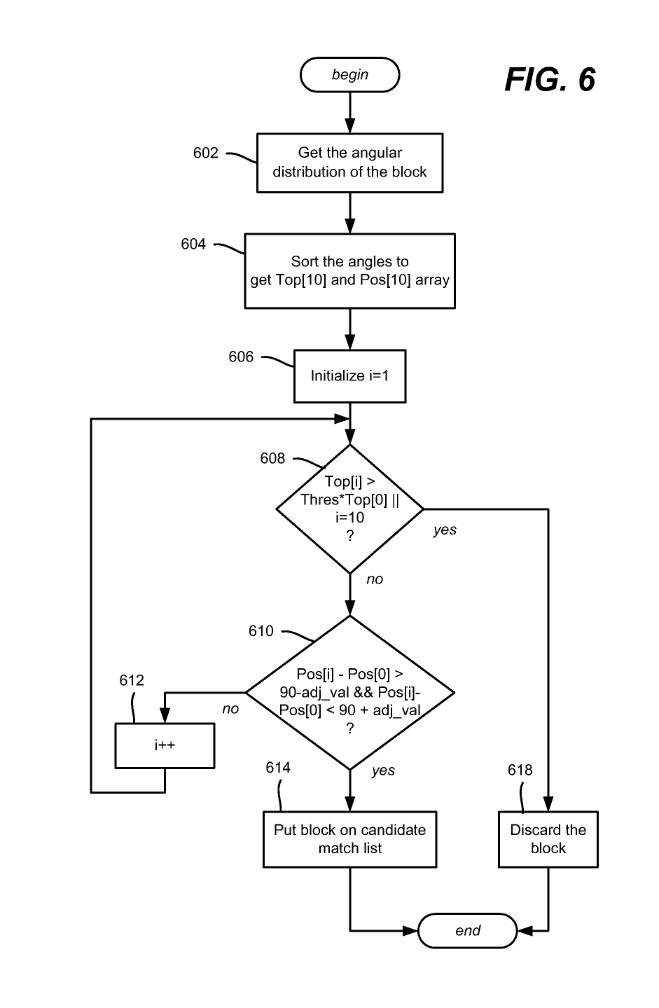

In general, a similar angular distribution pattern holds for real world image blocks that are within or part of a QR Code®. Thus, the application needs to efficiently and reliably identify these candidate blocks, given a somewhat potentially fuzzy distribution pattern. To this end, the application performs an algorithm referred to as candidate block selection, as generally illustrated via the example sub-step 505 of FIG. 5, shown in more detail in the example steps of the flow diagram of FIG. 6. The algorithm works primarily by first obtaining the angular distribution of a block (step 602), and then using a quick sort to sort the distribution values (step 602).

Once sorted, the algorithm selects the highest values (according to some threshold) and determines if they are within an acceptable range indicative of a QR Code® distribution. In the example of FIG. 6, the top ten angle counts are chosen via steps 608 and 612. Via step 610, these top counts are evaluated to determine whether enough of them are within positioned at the desired angle (e.g., 90°), within a general range (adj_val), e.g., generally vertical and/or horizontal. If so, the block is a candidate block (step 614), otherwise it is discarded (step 616). The intuition is that the highest values are representative of the entire block distribution, while at the same time avoiding noise. Using this algorithm thus maintains accuracy while running with high performance and efficiency.

After obtaining a list of candidate blocks that may be part of a QR Code®, the process removes any false positives and determines the best possible candidate block within a region, as generally represented by step 507 of FIG. 5. In general, this is based on where the various candidate blocks are grouped together with other candidate blocks in the image; those with the tightest grouping correspond to the region that is most likely to contain the barcode symbol.

To implement this step, the image is scanned with a logical cursor that is sized to be some multiple of the block size; (note that the actual size of the cursor is application-specific). The number of candidate blocks that are located within the cursor is tracked as the cursor moves throughout the image. After scanning the image, the cursor position that contained the most candidate blocks indicates the region that is most likely to contain the barcode symbol.

Once the region with the most candidate blocks is discovered, the best candidate block is found by iterating through the candidate blocks in the region and determining which one has the closest angular distribution to the ideal case.

After identifying the best candidate block, it is considered a seed, and used by a fast region grow algorithm to establish the approximate bounding box of the QR Code®. The algorithm works by evaluating the nearby blocks (the actual number of blocks is application-specific) in the directions directly above, below, left, and to the right of the current block. The evaluation at each block determines whether the angular distribution loosely (by some threshold) matches that of a QR Code® angular distribution. If so, this becomes the current block and the processing continues recursively. In this manner, the approximate bounding box is known, and the barcode symbol thus located.

At this time, the barcode symbol's location is known, whereby it may be decoded or otherwise used by further processing. Note that as part of the decoding, the further processing can locate the QR Code® position detection patterns (three small black boxes) located at the three corners of the symbol to determine a bounding box, which were heretofore not needed in locating the QR Code® symbol itself.

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. In a computing environment, a method comprising, locating a two-dimensional barcode symbol within an image, including processing the image to determine angular signatures corresponding to pixels, and determining a location of the barcode symbol based on the angular signatures.

2. The method of claim 1 wherein each pixel is represented by an angle, and wherein processing the image comprises dividing the image into blocks, and for each pixel in a block, determining an angle corresponding to that pixel, and for each possible angle, counting the number of pixels in that block that correspond to that angle and maintaining the counts for the possible angles.

3. The method of claim 2 further comprising, normalizing angles greater than one-hundred eighty degrees such that the possible angles range from zero to one-hundred eighty degrees.

4. The method of claim 2 wherein the angle corresponding to a pixel is maintained in a storage space that contained the pixel's original pixel value.

5. The method of claim 2 wherein processing the image to determine angular signatures comprises evaluating the blocks to detect whether each block contains pixels with an angular signature that indicates whether that block qualifies as a candidate block with respect to being part of the barcode symbol.

6. The method of claim 5 wherein evaluating the blocks comprises determining from the counts whether the block contains angles that are mostly generally vertical or generally horizontal, or mostly generally vertical and generally horizontal.

7. The method of claim 5 further comprising, determining a best candidate block by processing the candidate blocks.

8. The method of claim 7 wherein the image is divided into regions, and wherein determining the best candidate block comprises determining which region has the most candidate blocks.

9. The method of claim 8 wherein determining a location of the barcode symbol comprises approximating a bounding box that contains the barcode symbol, including by evaluating other blocks proximate the best candidate block to determine whether the angular signature of each of those other blocks indicates that the other block corresponds to part of the barcode symbol.

10. In a computing environment, a system comprising, a localization program that identifies where a barcode symbol is located within an image, including by evaluating pixels of the image to associate an angle with each pixel, and by determining from the angles associated with the pixels where the barcode is located.

11. The system of claim 10 wherein the barcode symbol is a QR Code®.

12. The system of claim 10 wherein the localization program is run in a mobile telephone device having a camera.

13. The system of claim 10 wherein the localization program determines wherein the barcode is located by determining a region that has at least a threshold number of generally vertical or generally horizontal angles, or both generally vertical and generally horizontal angles.

14. The system of claim 13 wherein the localization program determines the region by dividing the image into blocks, determining which blocks are candidate blocks based on a number of generally vertical or horizontal angles in each block, or both generally vertical and generally horizontal angles in each block, and determining the region based on a number of candidate blocks that are within that region relative to numbers of candidate blocks in other regions.

15. The system of claim 14 wherein the localization program determines which blocks are the candidate blocks based on a number of generally vertical or generally horizontal angles in each block, or both generally vertical and generally horizontal angles in each block

16. The system of claim 14 wherein the localization program determines wherein the barcode is located by choosing a selected block within the region, and growing a bounding box by evaluating other blocks proximate the selected block to determine which other blocks contain angular signatures indicative of the pixels of those blocks being part of the barcode symbol.

17. The system of claim 16 wherein the localization program chooses the selected block by determining which candidate block in the region has the most generally vertical angles, or the most generally horizontal angles, or the most generally vertical and the most generally horizontal angles.

18. One or more computer-readable media having computer-executable instructions, which when executed perform steps, comprising:
dividing an image into blocks;
performing an angular distribution analysis to determine which blocks are candidate blocks with respect to being part of a barcode symbol;
dividing the image into regions that are larger than the blocks;
determining a selected region within the image where at least part of the barcode symbol is located based on how many candidate blocks are within each region; and
identifying a bounding box that contains the barcode symbol by growing the bounding box based on a block within the selected region.

19. The one or more computer-readable media of claim 18 wherein performing the angular distribution analysis comprises, for each block, determining an angle value for each pixel in the block, and counting the number of pixels for each possible angle value.

20. The one or more computer-readable media of claim 19 wherein performing the angular distribution analysis to determine which blocks are candidate blocks with respect to being part of the barcode symbol comprises, determining from the number of pixels for each possible angle value whether the block contains generally horizontal or generally vertical angles, or both generally horizontal and generally vertical angles.
